(19) United States
(12) Patent Application Publication
(10) Pub. No.: US 2023/0161903 A1
(43) Pub. Date: May 25, 2023

(54) METHODS AND SYSTEMS FOR SECURE PROCESSING OF PERSONAL IDENTIFIABLE INFORMATION

(71) Applicant: APPLYBOARD INC., Kitchener (CA)

(72) Inventor: Viktor Kopylov, Waterloo (CA)

(73) Assignee: APPLYBOARD INC., Kitchener, ON (CA)

(21) Appl. No.: 17/990,045

(22) Filed: Nov. 18, 2022

Related U.S. Application Data
(60) Provisional application No. 63/281,440, filed on Nov. 19, 2021.

(51) Int. Cl. G06F 21/62

(52) U.S. Cl. CPC G06F 21/6245

(57) ABSTRACT

A method and system of extracting personal identifiable information from an image of an identification document having a known structure is described. The system receives an image in an enhanced security networking environment. The system then parses the image into at least one sub-image based on the known structure and dissimulates the sub-image amongst dissimulation images of similar personal identifiable information. The sub-image and dissimulation images are then sent to an extraction service arranged to extract a string of characters from each sub-image and dissimulation image. Once extracted, the strings of characters can be sent back to the system without any personal identifiable information having been compromised.

### CROSS-REFERENCE TO PREVIOUS APPLICATION

This application claims priority from U.S. provisional patent application No. 63/281,440 filed on Nov. 19, 2021, which is incorporated herein by reference in its entirety.

### FIELD

The present disclosure relates to the field of cybersecurity and privacy. In particular, the present disclosure relates to methods and systems for securely, processing, exchanging, and extracting personal identifiable information from structured documents.

### INTRODUCTION

Several industries use computerized application processes where applicants collect and compile data into requests to be evaluated by a multitude of receiving systems. Collecting, processing, exchanging, extracting and compiling such data can entail a significant amount of cybersecurity and privacy risks, particularly when such data includes Personal Identifiable Information (PII) of an applicant or individuals associated with an applicant.

Typically, applications are completed and/or submitted online. For example, job seekers can submit applications directly to an online application system of an employer. In another example, an application system can receive program applications from a prospective student for a plurality of academic institutions and forward the program applications to the respective academic institutions. Such online applications can include a variety of data objects collected over time.

In some case, data objects can include personal identifiable information, such as, but not limited to the full name or personal telephone number or address information of an applicant. In order to increase ease of use for applicants, application systems can be configured to receive images of identification (ID) documents directly from applicants and then extract personal identifiable information from such identification documents, thereby eliminating the need for applicants to enter personal identifiable information manually.

Information extraction technologies, such as Optical Character Recognition (OCR) models, are complex, computationally expensive, and onerous to design, build, train, maintain and improve. As such, most applications use online third-party extraction services via an application program interface (API). Such online third-party extraction services handle significant amounts of data and are therefore more robust than custom extraction services. Using such online services to extract personal identifiable information introduces significant security and privacy risks. As such, implementation of most known application systems entails the expense of designing, building, training, maintain and improving inferior custom extraction services that have the advantage that they can be located in areas of an application system's internal networks that benefit from enhanced security protocols.

There is therefore a clear need for improved methods and systems for secure processing, exchange and extraction of personal identifiable information from identification documents.

### SUMMARY

The following summary is intended to introduce the reader to various aspects of the applicant's teaching, but not to define any invention.

The various embodiments described herein generally relate to methods and systems for the secure processing, exchange, and extraction of personal identifiable information from structured identification documents of individuals.

In one aspect of the present disclosure, there is provided a method of extracting personal identifiable information from an image of an identification document having a known structure. The method comprises the step of receiving the image in an enhanced security networking environment. The method also comprises the step of parsing the image into at least one sub-image based on the known structure. The at least one sub-image contains an image of non-personal identifiable information. The method also comprises the step of associating the at least one sub-image with an identifier. The method also comprises the step of preparing an exchange package comprising the at least one sub-image and the identifier together with one or more dissimulation images of similar non-personal identifiable information. Each dissimulation image is associated with a different identifier. The method also comprises the step of sending the exchange package to an information extraction service arrange to extract a string of characters from each sub-image and dissimulation image and associate each extracted string of characters to the identifier associated with the image from which the respective string of characters was extracted in order to produce an extracted package. The method also comprises the step of receiving the extracted package in the enhanced security networking environment.

In another aspect of the present disclosure, there is provided a system for extracting personal identifiable information from an image of an identification document having a known structure. The system comprises a processor and at least one non-transitory memory containing instructions which when executed by the processor cause the system to receive the image in an enhanced security networking environment. The processor is also caused to parse the image into at least one sub-image based on the known structure, the at least one sub-image containing an image of non-personal identifiable information. The processor is also caused to associate the at least one sub-image with an identifier. The processor is also caused to prepare an exchange package comprising the at least one sub-image and the identifier together with one or more dissimulation images of similar non-personal identifiable information. Each dissimulation image is associated with a different identifier. The processor is also caused to send the exchange package to an information extraction service arrange to extract a string of characters from each sub-image and dissimulation image and associate each extracted string of characters to the identifier associated with the image from which the respective string of characters was extracted in order to produce an extracted package. The processor is also caused to receive the extracted package in the enhanced security networking environment.

### DRAWINGS

The drawings included herewith are for illustrating various examples of apparatus, systems, and processes of the present specification and are not intended to limit the scope of what is taught in any way. In the drawings:

FIG. 1 is a representation of an identification document containing personal identifiable information;

FIG. 2 is a block diagram showing the functional components of an application system environment in accordance with the prior art;

FIG. 3 is a block diagram showing the functional components of an application system environment in accordance with embodiments of the present disclosure;

FIG. 4 is a representation of an example of an identification document template for the identification document of FIG. 1;

FIG. 5 is a flow chart of extraction methods in accordance with the present disclosure;

FIG. 6 is a timing diagram of extraction methods in accordance with the present disclosure; and

FIG. 7 is a representation of an exchange package provided by embodiments of methods and systems of the present disclosure.

### DESCRIPTION OF VARIOUS EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims. Numerous specific details are set forth in the following description to provide a thorough understanding of the invention. These details are provided for the purpose of non-limiting examples and the invention may be practiced according to the claims without some or all of these specific details. Technical material that is known in the technical fields related to the invention has not been described in detail so that the invention is not unnecessarily obscured.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein, the terms “personal identifiable information” and “PII” generally refer to any representation of information that permits the identity of an individual to whom the information applies to be reasonably inferred by either direct or indirect means. This information can be maintained in either paper, electronic or other media. Examples of personal identifiable information include, but are not limited to, full name, social security number (SSN), passport number, driver's license number, taxpayer identification number, patient identification number, financial account number, or credit card number, email address, personal telephone numbers, photographic images (particularly of face or other identifying characteristics), fingerprints, or handwriting, retina scans, voice signatures, or facial geometry, automobile vehicle identification number (VIN), and Internet Protocol (IP) or Media Access Control (MAC) addresses that exclusively link to an individual.

As used herein, the terms “non personal identifiable information” and “NPII” generally refer to any representation of information that does not allow the identity of an individual to whom the information applies to be reasonably inferred by either direct or indirect means. Examples of personal identifiable information include, but are not limited to, date of birth, place of birth, race, religion and portions of personal identifiable information that do not allow the identity of an individual to whom the information applies to be reasonably inferred by either direct or indirect means, such as, for example, the first name of an individual.

As used herein the term “identification document” generally refers to any document that comprises personal identifiable information and that is set out in a known structure, i.e., having certain elements of information being situated at known locations in the physical layout of the document and/or the physical layout of a page of the document. Identification documents include, but are not limited to, passports, driver's licenses, military identification cards, government-issued identification cards, health insurance cards, citizenship cards, permanent resident cards, social security cards, social insurance cards, hospital records, baptismal certificates, credit cards, debits cards, marriage certificate, utility bills, voter's registration cards and library cards.

The various embodiments described herein generally relate to methods (and associated systems configured to implement the methods) of extracting personal identifiable information from images of identification documents. Applications can be directed to a variety of opportunities, including but not limited to academic programs, employment, certifications, financial products, insurance products, and social services. An application system can receive personal identifiable information from applicants. For example, applicant system can include but is not limited to academic institutions, employers, licensing bodies, financial service providers, insurance providers, and government or non-profit entities. Furthermore, applicants can be an individual or an entity, such as a corporation.

For example, an application to an academic program may require personal identifiable information, academic information, writing samples, and letters of recommendation. Upon creation of an application (i.e., starting the application), the applicant can provide some personal identifiable information from a computing device associated with the applicant. The applicant can provide any such information by submitting the information through an online portal, using client software on the computing device and/or submitting images taken of physical identification documents.

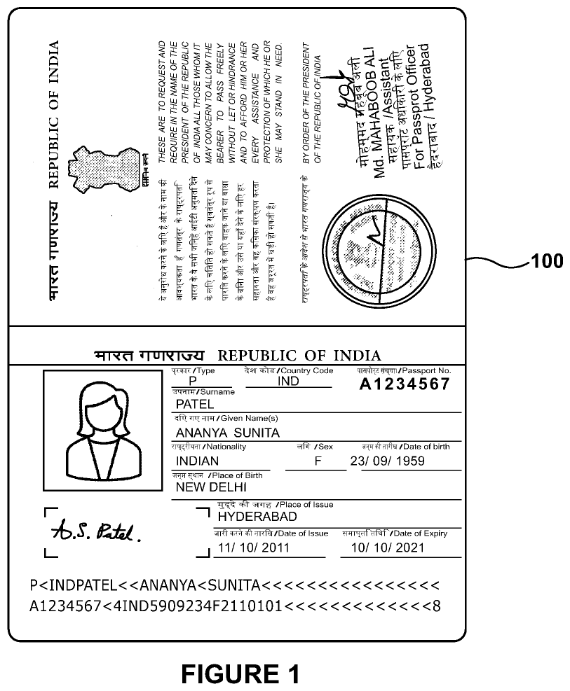

FIG. 1 is a representation of an identification document 100 that can be used with methods and systems in accordance with the present disclosure. In the example shown in FIG. 1, the identification document 100 is the picture page of a passport. It will however be appreciated that any other identification document could be used in accordance with the methods and systems disclosed herein.

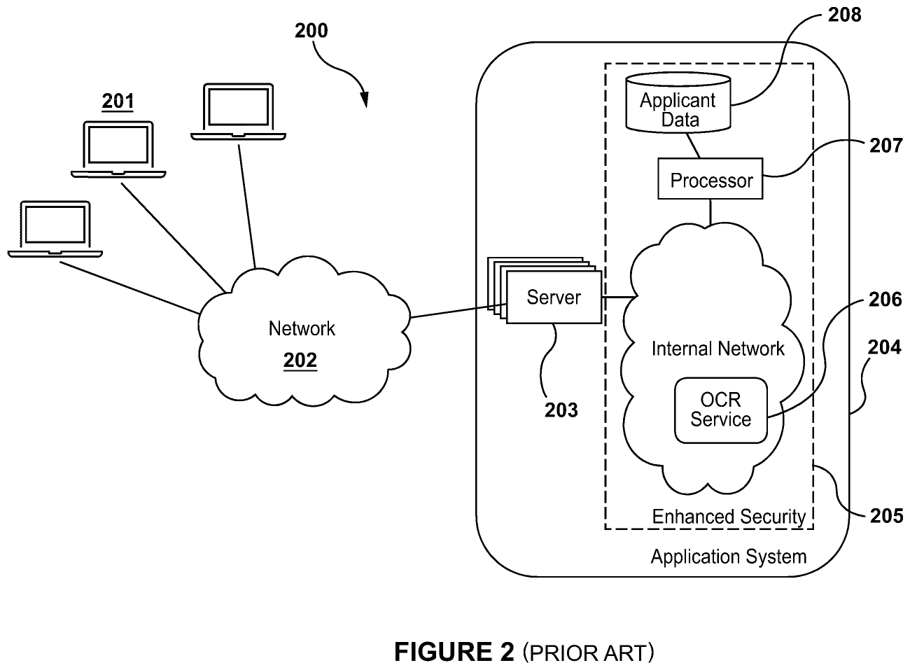

FIG. 2 is schematic diagram of an environment 200 for processing application data in accordance with the prior art. The environment 200 includes applicant devices 201 in data communication with an application system 204 over a network 202. The application system 204 comprises a server 203, an internal network, a processor 207, memory 208 and an optical character recognition (OCR) service 206. The processor 207, custom optical character recognition (OCR) service 206 and server 203 are configured for bidirectional data communications through the internal network. The memory 208 stores application data, which includes personal identifiable information.

The application system 204 is configured to receive images of identification documents from applicant devices 201. Once received, processor 207 of application system 204 uses the OCR service 206 to extract personal identifiable information from the images of the identification documents 100 for subsequent storage in memory 208 by processor 207. Typically, such a process includes processor 207 sending the image to the OCR service 206, the OCR service 206 extracting the personal identifiable information from the image, and the OCR service 206 sending the extracted personal identifiable information back to processor 207 for subsequent processing and/or storage. Because the OCR service 206 handles personal identifiable information, and sends that information to processor 207, the OCR service 206, processor 207 and the data communication therebetween must be located within an enhanced security networking environment 205. As used herein, the expression “enhanced security” generally refers to a computer networking environment in which PII data is less exposed to access and/or interference by potentially malicious third parties. Enhanced security can include, but is not limited to, network architectures making use of firewalls, network segmentation, access control, virtual private networks (VPNs), zero trust network access (ZTNA) and/or Intrusion Prevention Systems (IPS). As will be appreciated by the skilled reader, any other suitable cyber security and data privacy measures can be implemented in the enhanced security networking environment 205.

The first significant technical disadvantage of prior art application system 204 is the cost and complexity of creating and maintaining an enhanced security networking environment 205 increases non-linearly with the size of the environment 205 and the number of networking elements therein. As such, having to include the OCR service 206 and the parts of the internal network that are used to ensure data communications between the processor 207 and the OCR service 206 in the enhance security networking environment 205 is costly and complex.

A second significant technical disadvantage of prior art application system 204 is that OCR service 206 is complex, computationally expensive, and onerous to design, build, train, maintain and improve. Moreover, modern OCR services use machine learning (ML), which typically output better predictions when trained on relatively large datasets. Because OCR service 206 is typically trained and improved using images exclusively received by application system 204, it may not be as accurate as other types of online OCR services that are trained by very large volumes of unsecured data.

The skilled reader will identify and understand further technical disadvantages and shortcomings associated with prior art systems by reading the following description of the methods and system disclosed herein.

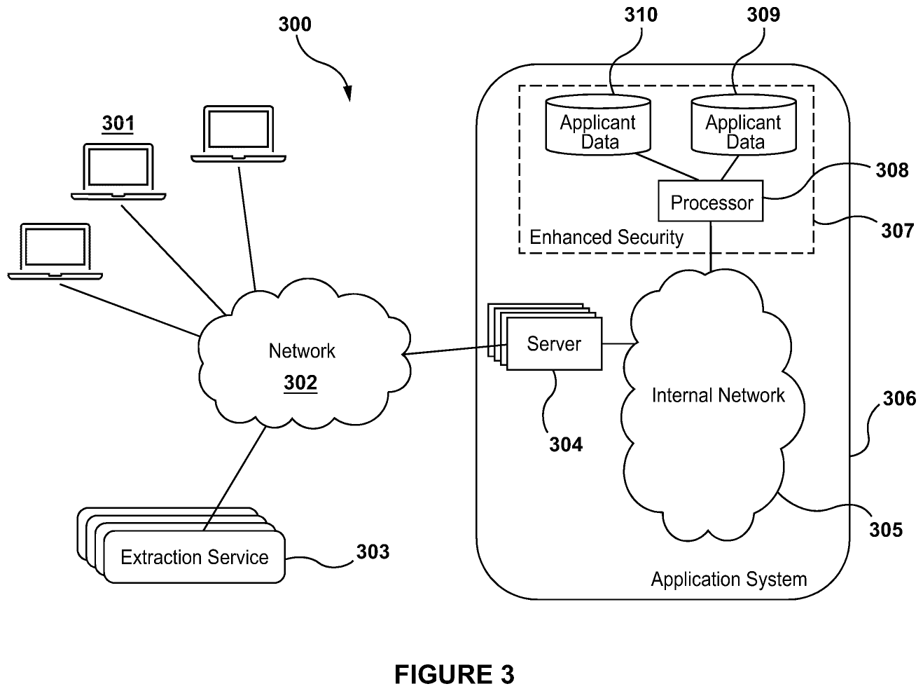

FIG. 3 is schematic diagram of an environment 300 for processing application data in accordance with embodiments of the present disclosure. In some embodiments, the environment 300 includes applicant devices 301 in data communication with an application system 306 over a network 302. The network 302 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the applicant devices 301 and the application system 306.

In some embodiments, the applicant devices 301 each include a computing device running a user application with storage, communication, and processing means. However, it is contemplated that in other embodiments, other computer systems may be used to communicate with application system 306. For example, in some embodiments, the applicant devices 301 may include a desktop computer, a tablet computer, a laptop, or similar, or in other embodiments, a smart phone running an operating system such as, for example, Android®, iOS®, Windows® mobile, or similar.

In some embodiments, the application system 306 comprises a server 304, an internal network 305, a processor 308 and memory 309, 310. Although a single server 304 is described, it is understood that server 304 may refer to a combination of computers and/or servers, such as in a cloud computing environment. Although a single processor 308 is shown, the term “processor” as discussed herein refers to any quantity and combination of a processor and may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

In some embodiments, processor 308 and server 304 are configured for bidirectional data communication through the internal network 305 of the application system 306, and accordingly can include network adaptors and drivers suitable for the type of network used.

Memory 309, 310 can include volatile storage and non-volatile storage. Memory 309, 310 comprises one or more memories for storing program code executed by processors 309, 310 and/or data used during operation of processors 309, 310. A memory of memory 309, 310 may be a semiconductor medium (including, for example, a solid-state memory), a magnetic storage medium, an optical storage medium, and/or any other suitable type of memory. A memory of memory 309, 310 may be read-only memory (ROM) and/or random-access memory (RAM), for example. In some embodiments, memory 310 may store a library of application data, which includes personal identifiable information. In some embodiments, memory 309 may store dissimulation data, as defined in more detail elsewhere herein.

Application system 306 can be implemented to assist prospective students making applications for admission to academic institutions. In other implementations, application system 306 may be included in government offices evaluating various bureaucratic requests, employer systems considering applications for employment, or other institutions which employ an at least partly computerized evaluation process. The method of extracting personal identifiable information from the image of an identification document includes the following steps. Applicant system 306 receives the image in an enhanced security networking environment 307.

In some embodiments, the applicant uploads the image together with an indication of the type of identification document being the subject of the image. In other embodiments, applicant system 306 may analyze the image and/or image metadata in order to determine what type of identification document is shown in the image. Once the type of identification document is determined, predetermined layout information relating to the type of identification document can be used to process the image, as described in more detail elsewhere herein. Layout information sets out the structure of the overall document or a part of the overall document, including the layout location of specific pieces of information on the document. Applicant system 306 can have access to databases comprising many types of identification documents. For each type of identification document, the database can store layout information that will allow application system 306 to parse images of specific types of identification documents without having to extract information from the images.

The processor 308 then parses the image into at least one sub-image based on the known structure of the identification document (i.e., the layout information). In the present example, the at least one sub-image consist of an image of non-personal identifiable information. The processor 308 then associates the at least one sub-image with an identifier. The identifier can be a numeric, alphabetic, alphanumeric, or other identifier allowing the sub-image to be identified by the application system 306. As will be appreciated by the skilled reader, any other form of identification may be used by the application system 306 to identify the sub-image.

The processor 308 then prepares an exchange package comprising the at least one sub-image and the identifier together with one or more dissimulation images of similar non-personal identifiable information. Each dissimulation image is associated with a different identifier, each of which different identifier also forms part of the exchange package. A dissimulation image is an image of a piece of non-personal identifiable information that is similar to the non-personal identifiable information found in the sub-image. For example, the sub-image may contain the date of birth of an applicant. In such a case, the dissimulation images would include images of dates taken from other identification documents that are not related to the applicant. In some embodiments, dissimulation images are stored in memory 309 and form part of dissimulation data from which the applicant system 306 can draw on to dissimulate a sub-image. In some embodiments, the dissimulation data can be selected randomly from the stored memory 309.

The processor 308 then sends the exchange package out of the enhanced security networking environment 307 to an information extraction service 303 arrange to extract a string of characters from each sub-image and dissimulation image and associate each extracted string of characters to the identifier associated with the image from which the respective string of characters was extracted in order to produce an extracted package. Because the information in the sub-image is not personal identifiable information, and because the sub-image is sent together with dissimulation data in the exchange package, there is no need to send the exchange package via secure communication means. The information extraction service 303 can then send the extracted package back to the application system 306. The application system 306 can then receive the extracted package in the enhanced security networking environment 307. The processor 308 can then use the identify of the original sub-image to extract the string of characters representing the correct non-personal identifiable information from the extracted package.

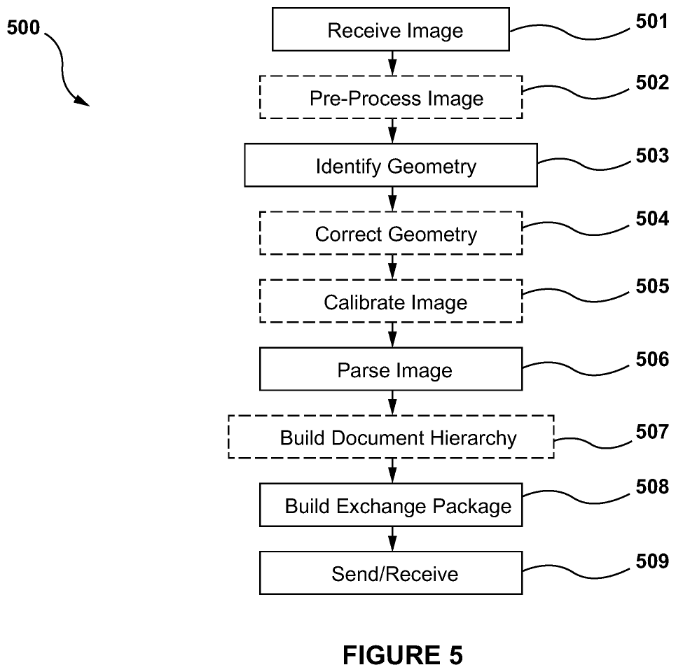

Now, with reference to FIGS. 3, 4, 5, 6 and 7, a more detailed account of embodiments of the methods and systems of the present disclosure will now be described.

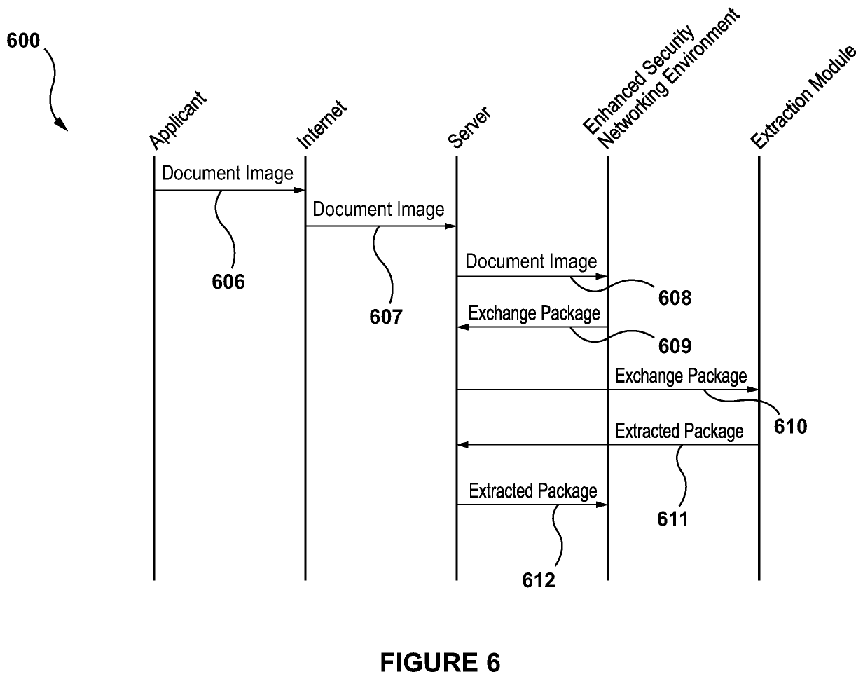

Applicants or other users of applicant devices 301 can take digital photographs of one or more identification documents 400 comprising personal identifiable information to create images of such identification documents 400. The applicants or other users of applicant devices 301 can then send such images to application system 306, via network 302, as shown in signals 606 and 607 in the timing diagram of FIG. 6. In some embodiments, network 302 is the Internet. In some embodiments, the image is sent using a browser and Hypertext Transfer Protocol Secure (HTTPS). In some embodiments, the image is sent through a Virtual Private Network (VPN). In other embodiments, the image may be sent from any of applicant devices 301 to application system 306 using any suitable secured data communication method.

Once received by server 304 of application system 306 at step 501, the image is sent to enhanced security networking environment 307, as shown by signal 608 in the timing diagram of FIG. 6. In some embodiments, server 304 can communicate with enhanced security networking environment 307 via a secure communication method using internal network 305.

In some embodiments, at step 502, the application system 306 can perform pre-processing of the received image. Such pre-processing can include, but it not limited to, improving and/or modifying image brightness, image contrast, creating black and white (binary) images, etc.

At step 503, the image can be classified into an identification document type. In some embodiments, the classification can be based on image document/file metadata. Once classified, an appropriate identification document template is selected for the identification document type. The identification document template comprises information relating to the layout and location of information in the identification document type. Constructing identification document templates is possible because the physical dimensions of each identification document type are well known and strictly regulated. For example, driver's licenses issued by the Canadian province of Ontario will show known pieces of information in accordance with a known layout on a card. As such, a template can be created in order to allow the parsing of an image of an Ontario driver's license such that sub-images of known pieces of information (e.g., date of birth) are created. Moreover, if the structure/layout of the identification document type is known, such sub-images of known pieces of information can be created without having to extract (through optical character recognition, for example) any information from the image itself.

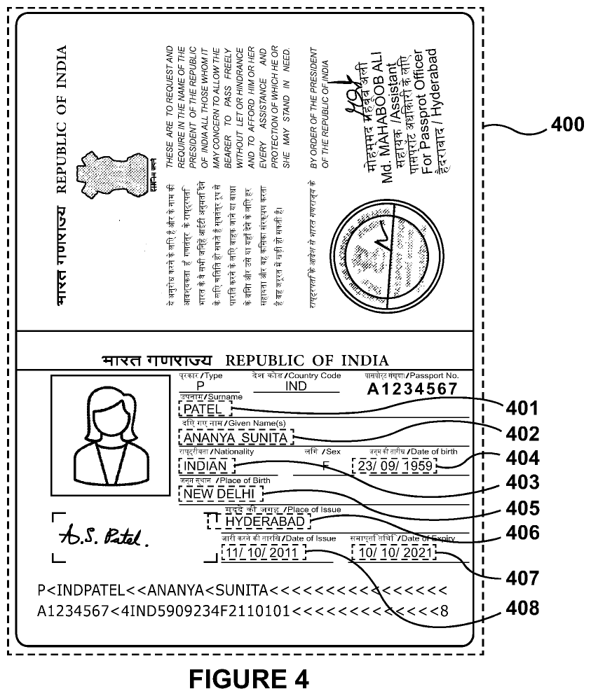

For example, FIG. 4 shows an identification document template for the picture page of an Indian passport. The template includes a number of layout fields which overlay areas in the image of the identification document that typically comprises specific pieces of information in an Indian passport. In the example of FIG. 4, the layout fields include last name 401, given names 402, nationality 403, date of birth 404, place of birth 405, place of issue 406, expiry date 407 and date of issue 408. While the sum of the information contained in image 400 is personal identifiable information, the individual pieces of information contained under the layout fields are non-personal identifiable information. The layout fields can therefore be used to parse the image in such a way as to extract sub-images relating to non-personal identifiable information.

Before the identification document template is used to parse the image it may be desirable and/or necessary to correct/normalize the image geometry at step 504. For example, a geometrically defined area (e.g., passport picture) of the identification document image (e.g., passport) can be used to correct the image geometry. As will be appreciated by the skilled reader, any one or more geometrically defined area of the identification document image can be used as a reference object to correct/normalize the image geometry. These may include, but are not limited to, a barcode, a holographic seal, an image, etc.

In the example in which the passport picture is used, known image filtering algorithms can be used to identify the rectangle in the image within which the passport picture is located. Once the edges of the passport picture are found, known algorithms can be used to determine the geometrical transformation matrixes that would need to be applied to correct/normalize the image. Correction/normalization of the image includes ensuring appropriate rotation, projection, scale, etc., of the image with reference to a reference image of a certain size taken at a normal angle in the centre of the identification document. As will be appreciated by the skilled reader, the above applies mutatis mutandis to other reference objects used to correct/normalize the image.

In some embodiments, once the image is corrected/normalized, it can be calibrated if desired and/or required. Calibration is the process by which the system can establish the physical dimensions of an image with respect to that of the identification document of which the image was taken. For example, the system could calibrate an image that is 600 pixels wide by 400 pixels high representing an identification document that is 120 mm wide and 80 mm high. In order to calibrate the image, the system calculates the following: x-spacing=120/600=0.5 mm/pix, and y-spacing=80/400=0.2 mm/pix.

Once calibrated, the results of these calculations can be used to identify the locations of elements in the image. For example, for a reference point on the image with coordinates x-pix=100, and y-pix=20, it may be necessary to determine the location of an object that we know is 10 mm to the right and 20 mm down from the origin reference point on the identification document. In this case, calibration allows the system to locate the object as follows: 10/0.5=20 (pixels to the right) and 20/0.2=100 (pixels down).

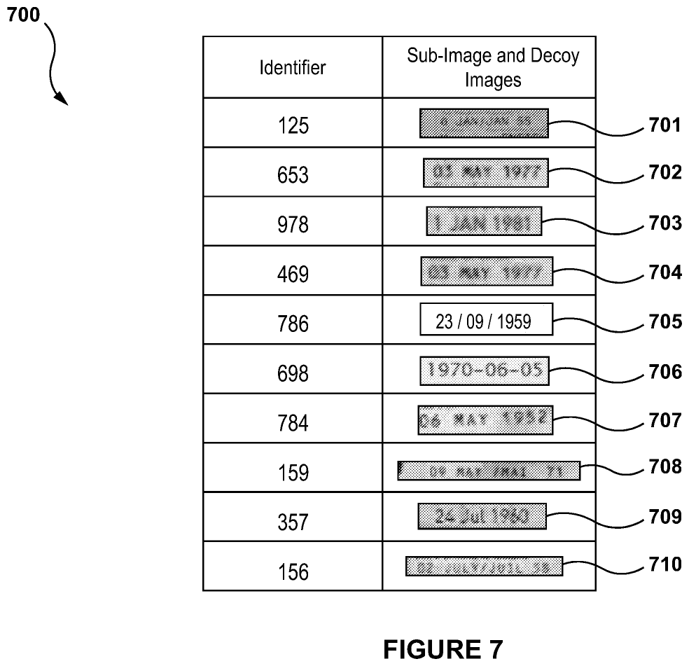

Then, at step 506, the processor 308 parses the image 400 into a number of sub-images using the appropriate identification document template. For example, as shown in FIGS. 4 and 7, the layout field 404 can be used to parse the image into a sub-image 705 showing the date of birth of the passport holder. As will be appreciated, an image may be parsed into several sub-images or into a single sub-image. Each sub-image is assigned an identifier and stored locally along with its associated identifier, as described in more detail elsewhere herein.

In some embodiments, an image can be parsed into several sub-images, each sub-image being an image of a particular piece of information found on the identification document. At this point, a document hierarchy can be built in which each sub-image is assigned a sub-image identifier and a parent image identifier, the parent image being the image from which the sub-image was parsed.

Then, at step 508, an exchange package 700 is created. As shown in the representation of FIG. 7, an exchange package 700 comprises a plurality sub-image and identifier pairs, in which one of the sub-image and identifier pairs includes the sub-image from which information is required to be extracted, and the remaining sub-image and identifier pairs include dissimulation images. The exchange package 700 can take the form of any suitable computer-readable file, such as, but not limited to, archive or ZIP files.

A dissimulation image is an image of a piece of non-personal identifiable information that is similar to the non-personal identifiable information found in the sub-image from which information is required to be extracted. In the example of FIG. 7, sub-image 705 has been parsed from image 400, and includes the date of birth of the passport holder. Sub-image 705 has been assigned identifier 786. Sub-images 701 to 704 and 706 to 710 have been assigned identifiers 125, 653, 978, 569, 698, 784, 159, 357 and 156, respectively. Each of sub-images 701 to 704 and 706 to 710 have been provided in the exchange package 700 as dissimulation images. A database of dissimulation images of various types of non-personal identifiable information can be stored in memory 309.

The final exchange package 700 therefore comprises a number of images of non-personal identifiable information, each assigned to a different identifier. Accordingly, without knowing the identifier associated the sub-image that was parsed from image 400, it is not possible to know which image is associated with image 400 and identification document 100.

Once the exchange package 700 is created, it can be sent to one or more extraction services 303, as shown in signals 609 and 610 of the timing diagram of FIG. 6. In some embodiments, the exchange package 700 is sent along with instructions to extract a string of characters from each sub-image and associate the string of characters to the identifier associated to the sub-image from which the string of characters is extracted. The extracted strings of characters and their associated identifiers can then be considered as an extracted package, which can then be sent back to the application system, as shown by signals 611 and 612 of the timing diagram of FIG. 6. In the example of FIG. 7, the following information could be contained in the extracted package:

| | |
|---|---|
| 125 | 6 JAN/JAN 55 |
| 653 | 3 MAY 1977 |
| 978 | 1 JAN. 1981 |
| 469 | 3 MAY 1977 |
| 786 | 23 Sep. 1959 |
| 698 | 1970 Jun. 5 |
| 784 | 6 MAY 1952 |
| 159 | 09 MAY/MAI 71 |
| 357 | 24 Jul. 1960 |
| 156 | 02 JULY/JUIL 58 |

As can be seen from the above table, the string of characters “23/09/1959” has successfully been extracted from sub-image 705 without any of the personal identifiable information associated with the passport holder of the passport image shown in FIG. 4 having been compromised. In some embodiments, the extraction service 303 is an online extraction service. In other embodiments, the extraction service is outside the enhanced security networking environment 307 but inside the application system 305. In yet other embodiments, the extraction service is provided by a combination of an extraction service provided internally to the application system 306 and an online extraction service. For example, it may be desirable to use an internal extraction service of some types of information (e.g., date of birth, nationality), but specialized external extraction services for other types of information (e.g., passport number).

Once received by the application system 306, the string of characters associated with sub-image 705 can be reincorporated into the document hierarchy as a string of characters and the strings of characters associated with the dissimulation images can be discarded.

In some embodiments, the extraction service comprises optical character recognition technology. As will be appreciated by the skilled reader, however, any other technology capable of extracting text strings from images and/or image data can be used.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof. It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers (referred to below as computing devices) may be a server, network appliance, embedded device, a personal computer, laptop, personal data assistant, cellular telephone, smart-phone device, tablet computer, a wireless device or any other computing device capable of being configured to carry out the methods described herein.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

The description and drawings merely illustrate the principles of the invention. It will thus be appreciated that those skilled in the art will be able to devise various arrangements that, although not explicitly described or shown herein, embody the principles of the invention and are included within the scope of the appended claims. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. A method of extracting personal identifiable information from an image of an identification document having a known structure, the method comprising the steps of:
receiving the image in an enhanced security networking environment;
parsing the image into at least one sub-image based on the known structure, the at least one sub-image containing an image of non-personal identifiable information;
associating the at least one sub-image with an identifier;
preparing an exchange package comprising the at least one sub-image and the identifier together with one or more dissimulation images of similar non-personal identifiable information, each dissimulation image being associated with a different identifier;
sending the exchange package to an information extraction service arranged to extract a string of characters from each sub-image and dissimulation image and associate each extracted string of characters to the identifier associated with the image from which the respective string of characters was extracted in order to produce an extracted package; and
receiving the extracted package in the enhanced security networking environment.

2. The method of claim 1 further comprising the step of:
pre-processing the image to produce a normalized image of the identification document.

3. The method of claim 2, wherein the pre-processing comprises one or more of de-skewing, rotating and calibrating the image.

4. The method of claim 1 further comprising the step of:
selecting a parsing template based on the type of identification document.

5. The method of claim 4, wherein the type of identification document can be any one of a passport issued by a specific country, a drivers' license issued by a specific authority, or any other known form or identification document issued by a known authority.

6. The method of claim 1, wherein the information extraction service is located outside of the enhanced security networking environment.

7. The method of claim 6, wherein the information extraction service is an online information extraction service.

8. The method of claim 1, wherein the information extraction service comprises an Optical Character Recognition (OCR) service.

9. The method of claim 1, wherein the non-personal identifiable information is any one of a date of birth, address, document issue date, first name, last name or place of birth.

10. The method of claim 1, wherein the image is received using a secured communication protocol.

11. The method of claim 10, wherein the secured communication protocol is Hypertext Transfer Protocol Secure (HTTPS).

12. A system for extracting personal identifiable information from an image of an identification document having a known structure, the system comprising:
a processor; and
at least one non-transitory memory containing instructions which when executed by the processor cause the system to:
i) receive the image in an enhanced security networking environment;
ii) parse the image into at least one sub-image based on the known structure, the at least one sub-image containing an image of non-personal identifiable information;
iii) associate the at least one sub-image with an identifier;
iv) prepare an exchange package comprising the at least one sub-image and the identifier together with one or more dissimulation images of similar non-personal identifiable information, each dissimulation image being associated with a different identifier;
v) send the exchange package to an information extraction service arranged to extract a string of characters from each sub-image and dissimulation image and associate each extracted string of characters to the identifier associated with the image from which the respective string of characters was extracted in order to produce an extracted package; and
vi) receive the extracted package in the enhanced security networking environment.

13. The system of claim 12 wherein the system is further caused to:
pre-processing the image to produce a normalized image of the identification document.

14. The system of claim 13, wherein the pre-processing comprises one or more of de-skewing, rotating and calibrating the image.

15. The system of claim 12, wherein the system is further caused to:
select a parsing template based on the type of identification document.

16. The system of claim 15, wherein the type of identification document can be any one of a passport issued by a specific country, a drivers' license issued by a specific authority, or any other known form or identification document issued by a known authority.

17. The system of claim 12, wherein the information extraction service is located outside of the enhanced security networking environment.

18. The system of claim 17, wherein the information extraction service is an online information extraction service.

19. The system of claim 12, wherein the information extraction service comprises an Optical Character Recognition (OCR) service.

20. The system of claim 12, wherein the non-personal identifiable information is any one of a date of birth, address, document issue date, first name, last name or place of birth.
